(19) United States
(12) Patent Application Publication
(10) Pub. No.: US 2017/0240794 A1
(43) Pub. Date: Aug. 24, 2017

(54) LIQUID CONCENTRATE OF A STRENGTH RETROGRESSION ADDITIVE

(71) Applicant: Halliburton Energy Services, Inc., Houston, TX (US)

(72) Inventors: Benjamin J. Iverson, Canton, OH (US); Robert L. Browning, Spring, TX (US); Marcus A. Duffy, Spring, TX (US)

(21) Appl. No.: 15/506,201

(22) PCT Filed: Sep. 23, 2014
(86) PCT No.: PCT/US2014/057002

§ 371 Date: Feb. 23, 2017

(51) Int. Cl. C09K 8/467; E21B 33/14; C04B 40/00; C04B 14/04; C04B 28/02

(52) U.S. Cl. CPC C09K 8/467; C04B 14/04; C04B 28/02; C04B 40/0039; E21B 33/14

(57) ABSTRACT

A liquid concentrate for use in a well that penetrates a subterranean formation comprising: a base liquid; and a strength retrogression additive, wherein the strength retrogression additive consists of particles of silicon dioxide containing crystalline regions, wherein the liquid concentrate has an activity of at least 40%. A method of cementing in a subterranean formation comprising: providing the liquid concentrate; forming a cement composition by adding a predetermined volume of the liquid concentrate to at least cement and water; and introducing the cement composition into the subterranean formation

### TECHNICAL FIELD

A liquid concentrate of a crystalline silicon dioxide strength retrogression additive is provided. The liquid concentrate can be added to a cement composition. The cement composition can be used in an oil or gas well.

### BRIEF DESCRIPTION OF THE FIGURES

The features and advantages of certain embodiments will be more readily appreciated when considered in conjunction with the accompanying figures. The figures are not to be construed as limiting any of the preferred embodiments.

FIG. 1 illustrates a system for preparation and delivery of a cement composition to a wellbore according to certain embodiments.

FIG. 2A illustrates surface equipment that may be used in placement of a cement composition into a wellbore.

FIG. 2B illustrates placement of a cement composition into an annulus of a wellbore.

FIG. 3 is a graph of rheology shear stress in Pascal to shear rate in reciprocal seconds for several liquid concentrates and cement compositions.

### DETAILED DESCRIPTION OF THE INVENTION

Oil and gas hydrocarbons are naturally occurring in some subterranean formations. In the oil and gas industry, a subterranean formation containing oil or gas is referred to as a reservoir. A reservoir may be located under land or off shore. Reservoirs are typically located in the range of a few hundred feet (shallow reservoirs) to a few tens of thousands of feet (ultra-deep reservoirs). In order to produce oil or gas, a wellbore is drilled into a reservoir or adjacent to a reservoir. The oil, gas, or water produced from the wellbore is called a reservoir fluid.

A well can include, without limitation, an oil, gas, or water production well, an injection well, or a geothermal well. As used herein, a “well” includes at least one wellbore. A wellbore can include vertical, inclined, and horizontal portions, and it can be straight, curved, or branched. As used herein, the term “wellbore” includes any cased, and any uncased, open-hole portion of the wellbore. A near-wellbore region is the subterranean material and rock of the subterranean formation surrounding the wellbore. As used herein, a “well” also includes the near-wellbore region. The near-wellbore region is generally considered the region within approximately 100 feet radially of the wellbore. As used herein, “into a well” means and includes into any portion of the well, including into the wellbore or into the near-wellbore region via the wellbore. As used herein, “into a subterranean formation” means and includes into any portion of a subterranean formation including, into a well, wellbore, or the near-wellbore region via the wellbore.

A portion of a wellbore may be an open hole or cased hole. In an open-hole wellbore portion, a tubing string may be placed into the wellbore. The tubing string allows fluids to be introduced into or flowed from a remote portion of the wellbore. In a cased-hole wellbore portion, a casing is placed into the wellbore that can also contain a tubing string. A wellbore can contain an annulus. Examples of an annulus include, but are not limited to: the space between the wellbore and the outside of a tubing string in an open-hole wellbore; the space between the wellbore and the outside of a casing in a cased-hole wellbore; and the space between the inside of a casing and the outside of a tubing string in a cased-hole wellbore.

During well completion, it is common to introduce a cement composition into an annulus in a wellbore to form a cement sheath. For example, in a cased-hole wellbore, a cement composition can be placed into and allowed to set in an annulus between the wellbore and the casing in order to stabilize and secure the casing in the wellbore. By cementing the casing in the wellbore, fluids are prevented from flowing into the annulus. Consequently, oil or gas can be produced in a controlled manner by directing the flow of oil or gas through the casing and into the wellhead. Cement compositions can also be used in primary or secondary cementing operations, well-plugging, or squeeze cementing.

As used herein, a “cement composition” is a mixture of at least cement and water. A cement composition can include additives. As used herein, the term “cement” means an initially dry substance that develops compressive strength or sets in the presence of water. An example of cement is Portland cement. A cement composition is a fluid and is generally slurry in which the water is the continuous phase of the slurry and the cement (and any other insoluble particles) is the dispersed phase. The continuous phase of a cement composition can include dissolved solids.

As used herein, a “fluid” is a substance having a continuous phase that tends to flow and to conform to the outline of its container when the substance is tested at a temperature of 71° F. (22° C.) and a pressure of 1 atmosphere “atm” (0.1 megapascals “MPa”). A fluid can be a liquid or gas. A homogenous fluid has only one phase; whereas a heterogeneous fluid has more than one distinct phase. A heterogeneous fluid can be: a slurry, which includes an external liquid phase and undissolved solid particles as the internal phase; an emulsion, which includes an external liquid phase and at least one internal phase of immiscible liquid droplets; a foam, which includes an external liquid phase and a gas as the internal phase; or a mist, which includes an external gas phase and liquid droplets as the internal phase.

During cementing operations, it is necessary for the cement composition to remain pumpable during introduction into the well and until the composition is situated in the portion of the well to be cemented. After the cement composition has reached the portion of the well to be cemented, the cement composition ultimately sets. As used herein, the term “set” and all grammatical variations thereof means the process of developing compressive strength and becoming hard or solid through curing. A cement composition that thickens too quickly while being pumped can damage pumping equipment or block tubing or pipes, and a cement composition that sets too slowly can cost time and money while waiting for the composition to set.

Different additives can be added to a cement composition prior to introduction into a well. The additives can be dry-blended into the cement composition. However, the exact make-up of the cement composition can change as oil and gas operations are carried out. For example, the concentration or the particle size of an additive may need to be adjusted on the fly. Therefore, it is common to require the housing or storage of a variety of additives with different particle sizes near the well site. Moreover, several “batches” of a cement composition may have to be prepared due to the variation in at least one of the ingredients, concentration, or particle size. The housing of certain additives, such as sand for a strength retrogression additive can require rather large storage containers. While this may be possible for on-land operations, the severely limited space available for off-shore operations makes such storage impractical.

Therefore, there is a need for improved liquid concentrates that can be used in cement compositions. It has been discovered that a strength retrogression additive can be made as a liquid concentrate with a much higher activity compared to other liquid concentrates. As used herein, a “liquid concentrate” means a base liquid containing at least 40% of an active additive (i.e., the liquid concentrate has an activity of at least 40%). As used herein, a “base liquid” is a liquid that is the external phase of the slurry.

A strength retrogression inhibitor can prevent a decline in the compressive strength of a cement composition over time. Cement generally contains four main types of minerals. Cement can also include other minerals in addition to the four main types. The minerals in cement are commonly referred to as the phases of the cement. The four main phases of cement are called alite, belite, aluminate, and ferrite.

“Alite” is a name for tricalcium silicate and “belite” is a name for dicalcium silicate. Cement chemist often abbreviate alite as C₃S and belite as C₂S. Both, alite and belite have different compositions compared to pure tricalcium silicate and dicalcium silicate because each one contains minor amounts of other oxides besides calcium oxide (CaO) and silicon dioxide (SiO₂).

“Aluminate” is a name for tricalcium aluminate, abbreviated by cement chemists as C₃A. Aluminate has a different composition compared to pure tricalcium aluminate because it contains minor amounts of other oxides besides CaO and aluminum oxide (Al₂O₃). “Ferrite” is a name for tetracalcium aluminoferrite, abbreviated by cement chemists as C₄AF. Ferrite has a different composition compared to pure tetracalcium aluminoferrite because it contains minor amounts of other oxides besides CaO, Al₂O₃, and iron oxide (Fe₂O₃).

When cement is mixed with water, the various phases of the cement can undergo a hydration reaction and form hydration products. The silicate phases (alite and belite) form hydration products of at least calcium silicate hydrate and calcium hydroxide (abbreviated by cement chemists as CH). Calcium silicate hydrate is often abbreviated as C—S—H. The dashes indicate there is no strict ratio of CaO to SiO₂ inferred. The aluminate and ferrite phases can form a variety of hydration products, including, hydrogarnet, ettringite, and monosulfoaluminate, depending on the amount of gypsum present in the cement.

Soon after mixing cement with water, aluminate reacts very quickly with the water to form an aluminate-rich gel. This reaction is highly exothermic, but generally lasts for only a few minutes after mixing. This stage in the hydration reaction is normally followed by a few hours of relatively low heat evolution, sometimes called the dormant stage. The dormant stage is when a cement composition can be placed in the location to be cemented. Eventually, the cement composition becomes too viscous to place in the desired location. At the end of the dormant stage, the alite and belite start to react with the water to form their hydration products. The hydration products occupy a larger volume in the cement composition compared to the solid phases. Consequently, the cement composition is converted from a viscous slurry into a rigid solid material. C—S—H can represent up to 70% by volume of the cement composition matrix and is primarily what gives the cement composition its mechanical properties, such as compressive strength.

However, this compressive strength can decline over time, especially in higher temperature wellbores. Therefore, a strength retrogression additive can be included in the cement composition. Sand, which is silica or silicon dioxide, can be used as a strength retrogression additive. It has been discovered that sand particles containing some or all crystalline regions can interact much more effectively compared to sand particles that only contain amorphous regions with the hydration products of a cement composition to prevent or decrease any decline in compressive strength over time.

If any laboratory test (e.g., rheology) requires the step of mixing, then the cement composition is mixed according to the following procedure. The liquid concentrate is mixed first by mixing the base liquid with the additive and any other optional ingredients, such as a suspending agent, together. Next, the water of the cement composition is added to a mixing container and the container is then placed on a mixer base. The motor of the base is then turned on and maintained at 4,000 revolutions per minute “rpm” (+/−200 rpm). The cement, a known volume of the liquid concentrate, and any other ingredients are added to the container at a uniform rate in not more than 15 seconds (s). After all the cement, liquid concentrate and any other ingredients have been added to the water in the container, a cover is then placed on the container, and the cement composition is mixed at 12,000 rpm (+/−500 rpm) for 35 s (+/−1 s).

As used herein, the “thickening time” is how long it takes for a cement composition to become unpumpable at a specified temperature and pressure. The pumpability of a cement composition is related to the consistency of the composition. The consistency of a cement composition is measured in Bearden units of consistency (Bc), a dimensionless unit with no direct conversion factor to the more common units of viscosity. As used herein, a cement composition becomes “unpumpable” when the consistency of the composition reaches 70 Bc.

A cement composition can develop compressive strength. Cement composition compressive strengths can vary from 0 psi to over 10,000 psi (0 to over 68.9 MPa). Compressive strength is generally measured at a specified time after the composition has been mixed and at a specified temperature and pressure. Compressive strength can be measured, for example, at a time of 24 hours. The non-destructive compressive strength method continually measures correlated compressive strength of a cement composition sample throughout the test period by utilizing a non-destructive sonic device such as an Ultrasonic Cement Analyzer (UCA) available from FANN® Instruments in Houston, Tex., USA. As used herein, the “compressive strength” of a cement composition is measured using the non-destructive method at a specified time, temperature, and pressure as follows. The cement composition is mixed. The cement composition is then placed in an Ultrasonic Cement Analyzer and tested at a specified temperature and pressure. The UCA continually measures the transit time of the acoustic signal through the sample. The UCA device contains preset algorithms that correlate transit time to compressive strength. The UCA reports the compressive strength of the cement composition in units of pressure, such as psi or MPa.

The compressive strength of a cement composition can be used to indicate whether the cement composition has initially set or is set. As used herein, a cement composition is considered “initially set” when the cement composition develops a compressive strength of 50 psi (0.3 MPa) using the non-destructive compressive strength method at a temperature of 212° F. (100° C.) and a pressure of 3,000 psi (20.7 MPa). As used herein, the “initial setting time” is the difference in time between when the cement and any other ingredients are added to the water and when the composition is initially set. As used herein, the “setting time” is the difference in time between when the cement and any other ingredients are added to the water and when the composition has set at a specified temperature. It can take up to 48 hours or longer for a cement composition to set. Some cement compositions can continue to develop compressive strength over the course of several days. The compressive strength of a cement composition can reach over 10,000 psi (68.9 MPa).

Rheology is a measure of how a material deforms and flows. As used herein, the “rheology” of a cement composition is measured according to API Recommended Practice 10-B2, First Edition, July 2005 as follows. The cement composition is mixed. The cement composition is placed into the test cell of a rotational viscometer, such as a FANN® Model 35 viscometer, fitted with a Bob and Sleeve attachment and a spring number 1. The cement composition is tested at the specified temperature and ambient pressure, about 1 atm (0.1 MPa). Rheology readings are taken at multiple revolutions per minute (rpm), for example, at 3, 6, 100, 200, 300, and 600 rpm.

According to an embodiment, a liquid concentrate for use in a well that penetrates a subterranean formation comprising: a base liquid; and a strength retrogression additive, wherein the strength retrogression additive consists of particles of silicon dioxide containing crystalline regions, wherein the liquid concentrate has an activity of at least 40%.

According to another embodiment, a method of cementing in a subterranean formation comprising: providing the liquid concentrate; forming a cement composition by adding a volume of the liquid concentrate to at least cement and water; and introducing the cement composition into the subterranean formation.

It is to be understood that the discussion of preferred embodiments regarding the liquid concentrate, the cement composition or any ingredient in the liquid concentrate and the cement composition, is intended to apply to the composition embodiments and the method embodiments. Any reference to the unit “gallons” means U.S. gallons.

The liquid concentrate includes a base liquid. The liquid concentrate can be a heterogeneous fluid. The liquid concentrate can be a slurry or a suspension. A suspension will tend to settle over time, thus the particles of a suspension are generally greater than 1 micrometer. The base liquid can be water. The water can be selected from the group consisting of freshwater, brackish water, and saltwater, in any combination thereof in any proportion. The liquid concentrate also includes a strength retrogression additive. The liquid concentrate can also contain other soluble or insoluble ingredients or additives. The strength retrogression additive consists of particles of silicon dioxide (also called silica or sand) containing crystalline regions. Some or all of the particles of the silicon dioxide can include crystalline regions. The particles of silicon dioxide can include 100% crystalline regions or some or all of the particles can also contain amorphous regions. The exact crystalline form can vary and can be, for example, monoclinic, cubic, hexagonal, tetragonal, etc. Without being limited by theory, it is believed that the crystalline regions interact to a much greater extent compared to amorphous regions with the hydration products of the phases of cement and water to inhibit or prevent a decline in the compressive strength of a cement composition over time.

The liquid concentrate has an activity of at least 40%, preferably at least 50%. The liquid concentrate can have an activity in the range of 40% or 50% to 85%. According to certain embodiments, the strength retrogression additive accounts for all of the insoluble particles making up the activity of the liquid concentrate. In other words, even though the liquid concentrate can include other additives, the concentration of the strength retrogression additive is such that the strength retrogression additive accounts for at least 40% or preferably at least 50% of the activity of the liquid concentrate. As used herein, the “activity” of the liquid concentrate is calculated as follows:

Activity=(weight of solid particles/weight of liquid concentrate)*100%

The strength retrogression additive can also be in a concentration of at least 35% by volume of the base liquid. The strength retrogression additive can also be in a concentration in the range of about 35% to about 70% by volume of the base liquid.

The method embodiments can further include the step of determining the maximum PVF (Packing Volume Fraction) of the liquid concentrate. The term “packing volume fraction” refers to the volume of the solid particulate materials in a fluid divided by the total volume of the fluid. The size ranges of the preferred solid particulate materials are selected, as well as their respective proportions, in order to provide a maximum (or close as possible to maximum) packing volume fraction so that the fluid can be as concentrated as possible. In order to obtain the maximum PVF, a combination of the following three features can be used. The first is the use of at least two particle sizes of the insoluble particles, such as the strength retrogression additive, wherein the at least two particle sizes are in size ranges “disjointed” from one another. The second feature is the choice of the proportions of the two particle sizes in relation to the mixing, such that the liquid concentrate, when mixed, is in a hindered settling state. The third feature is the choice of the proportions of the two particle sizes between each other, and according to their respective size ranges, such that the maximum PVF is at least substantially achieved for the sum total of all particles in the liquid concentrate. The step of determining the maximum PVF can further include the step of selecting the particle sizes of the strength retrogression additive and any other additives in order to attain the maximum PVF. Another feature is the choice of the proportions of the two or more particle sizes between each other, and according to their respective size ranges, such that the maximum packing volume fraction is at least substantially achieved for the sum total of all particles in the liquid concentrate. Accordingly, the packing volume fraction can be used to increase the activity of the liquid concentrate to at least 40% and preferably at least 50%.

The particle sizes of the strength retrogression additive and any other additives in the liquid concentrate can be “ultrafine,” “very fine,” “fine,” “small,” “medium,” “large,” and “very large” sized particles. As used herein: ultrafine is in the range from about 7 nanometers (nm) to about 50 nm; very fine is in the range from about 0.05 micrometers (μm) to about 0.5 μm; fine is in the range from about 0.5 μm to about 10 μm; small is in the range from about 10 μm to about 20 μm; medium is in the range from about 20 μm to about 200 μm; large is in the range from about 200 μm to about 800 μm; and very large is greater than about 1 millimeter (mm).

The liquid concentrate can be stable. As used herein, the term “stable” means that the majority of insoluble particles, such as the strength retrogression additive, remain uniformly suspended throughout the base liquid and do not settle to the bottom half of the liquid. Accordingly, the liquid concentrate can further include a suspending agent or viscosifier. The suspending agent or viscosifier can suspend the particles within the base liquid. This can be achieved, by way of example, by increasing the viscosity of the base liquid. However, the viscosity of the liquid concentrate should not be so great such that the liquid concentrate is unable to be poured from a storage or transportation container. The suspending agent or viscosifier can be any compound that provides a stable liquid concentrate. The suspending agent or viscosifier can also be in a sufficient concentration such that a stable liquid concentrate is provided. Should any settling occur, for example, during prolonged storage of the liquid concentrate, then preferably minor mixing or redistribution results in the particles becoming uniformly distributed throughout the base fluid.

The methods include providing the liquid concentrate. The step of providing can also include forming the liquid concentrate. The liquid concentrate can also be stored and transported to a well site. The liquid concentrate can also be formed on the fly at the well site.

The liquid concentrate is for use in a cement composition. The methods include forming a cement composition by adding a volume of the liquid concentrate to at least cement and water.

The cement composition includes cement. The cement can be a hydraulic cement. A variety of hydraulic cements may be utilized including, but not limited to, those comprising calcium, aluminum, silicon, oxygen, iron, and/or sulfur, which set and harden by a reaction with water. Suitable hydraulic cements include, but are not limited to, Portland cements, gypsum cements, high alumina content cements, slag cements, high magnesia content cements, and combinations thereof. In certain embodiments, the hydraulic cement may comprise a Portland cement. In some embodiments, the Portland cements are classified as Classes A, C, H, and G cements according to American Petroleum Institute, API Specification for Materials and Testing for Well Cements, API Specification 10, Fifth Ed., Jul. 1, 1990. Preferably, the cement is Class G or Class H cement.

The cement composition includes water. The water can be selected from the group consisting of freshwater, brackish water, and saltwater, in any combination thereof in any proportion. The cement composition can also include a water-soluble salt. Preferably, the salt is selected from sodium chloride, calcium chloride, calcium bromide, potassium chloride, potassium bromide, magnesium chloride, and any combination thereof in any proportion. The salt can be in a concentration in the range of about 0.1% to about 40% by weight of the water.

According to an embodiment, the cement composition has a density of at least 9 pounds per gallon “ppg” (1.1 kilograms per liter “kg/L”). The cement composition can have a density in the range of about 9 to about 22 ppg (about 1.1 to about 2.6 kg/L).

A predetermined volume of the liquid concentrate can be added to the cement and water and any other ingredients to form the cement composition. The predetermined volume of the liquid concentrate can be an amount such that the strength retrogression additive is in a concentration in the range of about 20% to about 70% by weight of the cement (bwoc). The final concentration of the strength retrogression additive in the cement composition can depend on the desired compressive strength of the cement composition and the desire to have as little decrease in compressive strength over time. Accordingly, the final concentration of the strength retrogression additive in the cement can vary and be selected based on the desired properties of the cement composition.

It is to be understood that while the cement composition can contain other ingredients, it is the strength retrogression additive that is primarily or wholly responsible for preventing a decline in the compressive strength of the cement composition. For example, a test cement composition consisting essentially of, or consisting of, the cement, the water, and the strength retrogression additive, and in the same proportions as the cement composition used in the wellbore, can have the stated percent change in compressive strength. Therefore, it is not necessary for the cement composition to include other additives, such as other compressive strength additives. It is also to be understood that any discussion related to a “test cement composition” is included for purposes of demonstrating that the cement composition can contain other ingredients, but it is the strength retrogression additive that partially or fully prevents the decline in compressive strength. Therefore, while it may not be possible to test the specific cement composition used in a wellbore operation in a laboratory, one can formulate a test cement composition to identify if the ingredients and concentration of the ingredients will provide the stated property (e.g., the stated percent change).

Accordingly, the strength retrogression additive can inhibit or prevent a decrease of the compressive strength of a test cement composition or the cement composition over a period of time. The period of time can be a time from 24 hours (hrs) to 72 hrs. The period of time can also be a time from forming the cement composition to the time the cement composition is no longer needed for use. The period of time can also be from a time of 12 hrs to a time of 14 days. The percent change in the cement composition's compressive strength over the time can be used to indicate the effectiveness of the percent of crystallinity of the silicon dioxide strength retrogression additive and the concentration of the strength retrogression additive. According to an embodiment, the compressive strength of the test cement composition or the cement composition at a final time of 72 hours has a percent change greater than −5% from the compressive strength of the test cement composition at an initial time of 24 hours when tested at a temperature of 300° F. (149° C.) and a pressure of 3,000 psi (20.7 MPa). As used herein the percent change of the compressive strength of a cement composition is calculated according to the following equation:

% change=(final−initial)/initial)*100%

where final is the compressive strength of the cement composition measured at the specified final time listed, and initial is the compressive strength of the cement composition measured at the specified initial time. The percent change can be a positive number or a negative number. If the number is positive, then the compressive strength has increased from the initial time to the final time. Conversely, if the number is negative, then the compressive strength has decreased from the initial time to the final time. Therefore, according to the embodiment wherein the compressive strength at a final time of 72 hours has a percent change greater than −5% from the initial time of 24 hours means that the compressive strength does not decrease by more than 5% from the initial time to the final time. According to a preferred embodiment, and keeping the testing parameters and final and initial times the same, the percent change is a positive number (i.e., 0 or greater), more preferably the percent change is greater than +2%. The concentration and the amount of crystallinity of the strength retrogression additive can also depend on the bottomhole temperature of the subterranean formation. As used herein, the term “bottomhole” means the location within the subterranean formation where the cement composition is situated. By way of example, at higher bottomhole temperatures, a higher concentration of the strength retrogression additive may be needed to inhibit or prevent a decrease in compressive strength over time.

According to another embodiment, the strength retrogression additive is in at least a sufficient concentration such that the test cement composition or the cement composition develops a compressive strength of at least 500 psi (3.4 MPa), preferably at least 1,000 psi (6.9 MPa) when tested at 24 hours, a temperature of 190° F. (88° C.), and a pressure of 3,000 psi (20.7 MPa).

The cement composition can have a thickening time in the range of about 5 to about 15 hours, alternatively of about 10 to about 12 hours, at the bottomhole temperature and pressure of the subterranean formation.

The cement composition can have a compressive strength greater than 1,000 psi (6.9 MPa), preferably greater than 2,000 psi (13.8 MPa), at the bottomhole temperature of the subterranean formation.

The cement composition can have an initial setting time of less than 48, preferably less than 24, hours at the bottomhole temperature of the subterranean formation. The cement composition can have a setting time of less than 48, preferably less than 24, hours at the bottomhole temperature of the subterranean formation.

It is to be understood that the liquid concentrate is added to the cement and water, and optionally other additives to form the cement composition before the cement composition is introduced into the subterranean formation. The cement composition can be formed on the fly at the well site. The liquid concentrate can be pourable. In this manner, a predetermined volume of the liquid concentrate can be poured into the cement and water and other possible ingredients to form the cement composition. This is useful, for example, because the formulation for a cement composition that is being used for a particular oil and gas operation can be modified on the fly by pouring the liquid concentrate into the mixture. This eliminates the need to make up an entirely new batch of cement composition to use in the subterranean formation as conditions change.

The cement composition can further include other additives. The other additives can be in a dry form and dry-blended with the liquid concentrate and cement and water to form the cement composition or in a liquid form and poured to form the cement composition. Examples of other additives include, but are not limited to, a filler, a friction reducer, a light-weight additive, a defoaming agent, a high-density additive, a mechanical property enhancing additive, a lost-circulation material, a filtration-control additive, a thixotropic additive, a set retarder, a set accelerator, and combinations thereof.

The cement composition can include a filler. Suitable examples of fillers include, but are not limited to, fly ash, sand, clays, and vitrified shale. Preferably, the filler is in a concentration in the range of about 5% to about 50% bwoc.

The cement composition can include a friction reducer. Suitable examples of commercially-available friction reducers include, but are not limited to, CFR-2™, CFR-3™, CFR-5LE™, CFR-6™, and CFR-8™, marketed by Halliburton Energy Services, Inc. Preferably, the friction reducer is in a concentration in the range of about 0.1% to about 10% bwoc.

Commercially-available examples of other additives include, but are not limited to, and are marketed by Halliburton Energy Services, Inc. under the tradenames HIGH DENSE® No. 3, HIGH DENSE® No. 4, BARITE™, and MICROMAX™, heavy-weight additives; SILICALITE™, extender and compressive-strength enhancer; WELLLIFE® 665, WELLLIFE ® 809, and WELLLIFE ® 810 mechanical property enhancers.

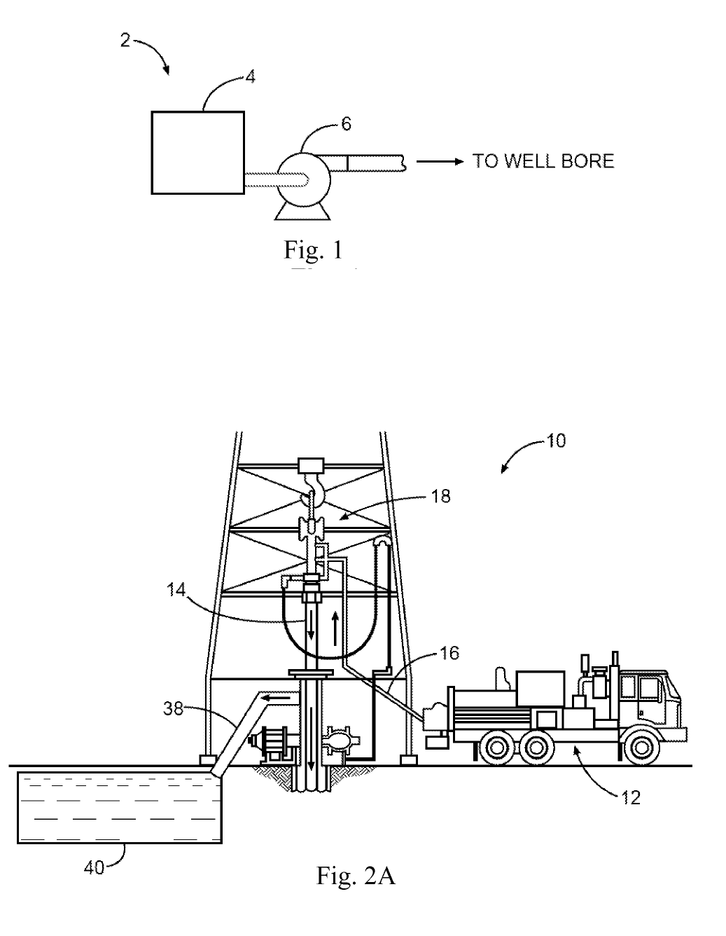

FIG. 1 illustrates a system that can be used in the preparation of a cement composition and delivery to a wellbore according to certain embodiments. As shown, the cement composition and the liquid concentrate and optional other ingredients can be mixed in mixing equipment 4, such as a jet mixer, re-circulating mixer, or a batch mixer, for example, and then pumped via pumping equipment 6 to the wellbore. In some embodiments, the mixing equipment 4 and the pumping equipment 6 can be located on one or more cement trucks. In some embodiments, a jet mixer can be used, for example, to continuously mix the cement composition, including water, as it is being pumped to the wellbore.

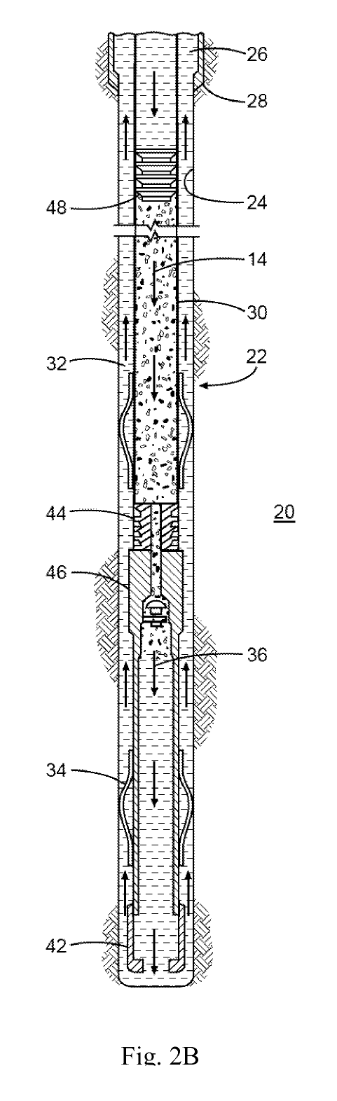

An example technique and system for introducing the cement composition into a subterranean formation will now be described with reference to FIGS. 2A and 2B. FIG. 2A illustrates surface equipment 10 that can be used to introduce the cement composition. It should be noted that while FIG. 2A generally depicts a land-based operation, those skilled in the art will readily recognize that the principles described herein are equally applicable to subsea operations that employ floating or sea-based platforms and rigs, without departing from the scope of the disclosure. The surface equipment 10 can include a cementing unit 12, which can include one or more cement trucks, mixing equipment 4, and pumping equipment 6 (e.g., as depicted in FIG. 1). The cementing unit 12 can pump the cement composition 14 through a feed pipe 16 and to a cementing head 18, which conveys the cement composition 14 downhole.

The method embodiments include the step of introducing the cement composition into the subterranean formation 20. Turning now to FIG. 2B, the cement composition 14 can be introduced into a subterranean formation 20. The step of introducing can include pumping the cement composition into the subterranean formation using one or more pumps 6. The step of introducing can be for the purpose of at least one of the following: well completion; foam cementing; primary or secondary cementing operations; well-plugging; squeeze cementing; and gravel packing. The cement composition can be in a pumpable state before and during introduction into the subterranean formation 20. In an embodiment, the subterranean formation 20 is penetrated by a well 22. The well can be, without limitation, an oil, gas, or water production well, an injection well, a geothermal well, or a high-temperature and high-pressure (HTHP) well. According to this embodiment, the step of introducing includes introducing the cement composition into the well 22. The wellbore 22 comprises walls 24. A surface casing 26 can be inserted into the wellbore 22. The surface casing 26 can be cemented to the walls 24 via a cement sheath 28. One or more additional conduits (e.g., intermediate casing, production casing, liners, etc.) shown here as casing 30 can also be disposed in the wellbore 22. One or more centralizers 34 can be attached to the casing 30, for example, to centralize the casing 30 in the wellbore 22 prior to and during the cementing operation. According to another embodiment, the subterranean formation 20 is penetrated by a wellbore 22 and the well includes an annulus 32 formed between the casing 30 and the walls 24 of the wellbore 22 and/or the surface casing 26. According to this other embodiment, the step of introducing includes introducing the cement composition into a portion of the annulus 32.

With continued reference to FIG. 2B, the cement composition 14 can be pumped down the interior of the casing 30. The cement composition 14 can be allowed to flow down the interior of the casing 30 through the casing shoe 42 at the bottom of the casing 30 and up around the casing 30 into the annulus 32. While not illustrated, other techniques can also be utilized for introduction of the cement composition 14. By way of example, reverse circulation techniques can be used that include introducing the cement composition 14 into the subterranean formation 20 by way of the annulus 32 instead of through the casing 30.

As it is introduced, the cement composition 14 may displace other fluids 36, such as drilling fluids and/or spacer fluids that may be present in the interior of the casing 30 and/or the annulus 32. At least a portion of the displaced fluids 36 can exit the annulus 32 via a flow line 38 and be deposited, for example, in one or more retention pits 40 (e.g., a mud pit), as shown on FIG. 2A. Referring again to FIG. 2B, a bottom plug 44 can be introduced into the wellbore 22 ahead of the cement composition 14, for example, to separate the cement composition 14 from the fluids 36 that may be inside the casing 30 prior to cementing. After the bottom plug 44 reaches the landing collar 46, a diaphragm or other suitable device ruptures to allow the cement composition 14 through the bottom plug 44. In FIG. 2B, the bottom plug 44 is shown on the landing collar 46. In the illustrated embodiment, a top plug 48 can be introduced into the wellbore 22 behind the cement composition 14. The top plug 48 can separate the cement composition 14 from a displacement fluid 50 and also push the cement composition 14 through the bottom plug 44.

The method embodiments can also include allowing the cement composition to set. The step of allowing can be performed after the step of introducing the cement composition into the subterranean formation. The method embodiments can include the additional steps of perforating, fracturing, or performing an acidizing treatment, after the step of allowing.

### EXAMPLES

To facilitate a better understanding of the present invention, the following examples of certain aspects of preferred embodiments are given. The following examples are not the only examples that could be given according to the present invention and are not intended to limit the scope of the invention.

Tables 1-3 lists the ingredients, concentrations, masses, and activity for three different liquid concentrates. SSA-1™ is 75 μm sized silicon dioxide and SSA-2™ is 150 μm sized silicon dioxide strength retrogression additives containing at least some crystalline regions. SA-1015™ suspending agent was used to create a stable liquid concentrate. Freshwater was used as the base liquid of the liquid concentrates. Concentrations are listed as: by volume of the water “bvow,” by weight of the water “bwow,” by volume of the additive “by of additive,” or by weight of the additive “bw of additive”—wherein reference to “the additive” means the strength retrogression additive. The activity was calculated according to the Detailed Description above. For example, for Liq. Conc. #3, there was a total of 480 grams of strength retrogression additive and the total weight of the liquid concentrate was 662 grams (288+192+181+0.5). The activity is equal to (480/662)*100%=73%.

As can be seen in the Tables, the combination of 2 different particle sizes of the strength retrogression additives resulted in a much higher activity compared to the liquid concentrates #1 and #2 that only contained 1 particle size. This indicates that by varying the number of different particle sizes and their relative concentrations, a higher activity concentrate can be prepared.

TABLE 1

| Liq. Conc. #1 Ingredients | Concentration | Mass | Activity |
|---|---|---|---|
| SSA-1 ™ | 50% bvow | 159.8 g | 73% |
| SA-1015 ™ | 0.25% bwow | 0.3 g | |
| Freshwater | 50% bv of additive | 60.2 g | |

TABLE 2

| Liq. Conc. #2 Ingredients | Concentration | Mass | Activity |
|---|---|---|---|
| SSA-2 ™ | 50% bvow | 159.8 g | 73% |
| SA-1015 ™ | 0.25% bwow | 0.3 g | |
| Freshwater | 50% bv of additive | 60.2 g | |

TABLE 3

| Liq. Conc. #3 Ingredients | Concentration | Mass | Activity |
|---|---|---|---|
| SSA-1 ™ | 40% bw of additive | 192 g | 73% |
| SSA-2 ™ | 60% bw of additive | 288 g | |
| SA-1015 ™ | 0.25% bwow | 0.5 g | |
| Freshwater | 50% bv of additive | 181 g | |

Two different cement compositions were prepared and contained freshwater and Class G cement and had a density of 15.8 pounds per gallon “ppg” (1.89 kilograms per liter “kg/L”). “Cement with Liq. Conc.” also included a predetermined volume of the liquid concentrate #3 wherein the concentration of the SSA-1™ and the SSA-2™ strength retrogression additives were in a concentration of 40% by weight of the cement “bwoc.” “Cement with Dry-Blended Add.” included the SSA-1™ and the SSA-2™ strength retrogression additives at a concentration of 40% bwoc, but instead of being in a liquid concentrate form, the SSA-1™ and the SSA-2™ additives were dry-blended with only the cement and water to form the cement composition.

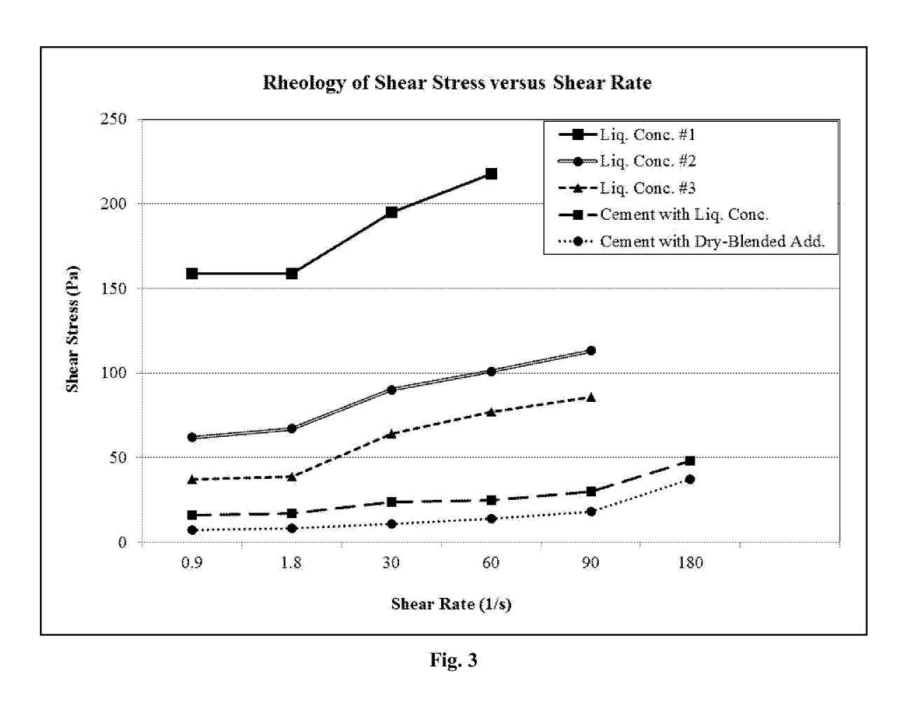

FIG. 3 is a graph of the rheologies as Shear Stress in Pascals (Pa) versus Shear Rate in reciprocal seconds (1/s) for the three liquid concentrates and the two cement compositions. As can be seen, the liquid concentrate #3 containing a mixture of particle sizes exhibited better rheology compared to liquid concentrates #1 and #2 that only had 1 size of particles. Moreover, the rheological profiles of the two cement compositions were comparable. This indicates that a liquid concentrate can be admixed into the cement and water effectively to form a cement composition compared to a dry-blending method.

The exemplary fluids and additives disclosed herein may directly or indirectly affect one or more components or pieces of equipment associated with the preparation, delivery, recapture, recycling, reuse, and/or disposal of the disclosed fluids and additives. For example, the disclosed fluids and additives may directly or indirectly affect one or more mixers, related mixing equipment, mud pits, storage facilities or units, fluid separators, heat exchangers, sensors, gauges, pumps, compressors, and the like used to generate, store, monitor, regulate, and/or recondition the exemplary fluids and additives. The disclosed fluids and additives may also directly or indirectly affect any transport or delivery equipment used to convey the fluids and additives to a well site or downhole such as, for example, any transport vessels, conduits, pipelines, trucks, tubulars, and/or pipes used to fluidically move the fluids and additives from one location to another, any pumps, compressors, or motors (e.g., topside or downhole) used to drive the fluids and additives into motion, any valves or related joints used to regulate the pressure or flow rate of the fluids, and any sensors (i.e., pressure and temperature), gauges, and/or combinations thereof, and the like. The disclosed fluids and additives may also directly or indirectly affect the various downhole equipment and tools that may come into contact with the fluids and additives such as, but not limited to, drill string, coiled tubing, drill pipe, drill collars, mud motors, downhole motors and/or pumps, floats, MWD/LWD tools and related telemetry equipment, drill bits (including roller cone, PDC, natural diamond, hole openers, reamers, and coring bits), sensors or distributed sensors, downhole heat exchangers, valves and corresponding actuation devices, tool seals, packers and other wellbore isolation devices or components, and the like.

As used herein, the words “comprise,” “have,” “include,” and all grammatical variations thereof are each intended to have an open, non-limiting meaning that does not exclude additional elements or steps.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present invention. While compositions and methods are described in terms of “comprising,” “containing,” or “including” various components or steps, the compositions and methods also can “consist essentially of” or “consist of” the various components and steps. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

What is claimed is:

1. A method of cementing in a subterranean formation comprising:
providing a liquid concentrate having an activity of at least 40%, wherein the liquid concentrate comprises:
(A) a base liquid; and
(B) a strength retrogression additive, wherein the strength retrogression additive consists of particles of silicon dioxide containing crystalline regions;
forming a cement composition by adding a predetermined volume of the liquid concentrate to at least cement and water; and
introducing the cement composition into the subterranean formation.

2. The method according to claim 1, wherein the liquid concentrate is a heterogeneous fluid.

3. The method according to claim 2, wherein the liquid concentrate is a slurry or a suspension.

4. The method according to claim 1, wherein the particles of the silicon dioxide includes 100% crystalline regions.

5. The method according to claim 1, wherein some or all of the particles of the silicon dioxide further includes amorphous regions.

6. The method according to claim 1, wherein the liquid concentrate has an activity of at least 50%.

7. The method according to claim 1, wherein the liquid concentrate has an activity in the range of 40% to 85%.

8. The method according to claim 1, wherein the strength retrogression additive accounts for all of the insoluble particles for the activity of the liquid concentrate.

9. The method according to claim 1, wherein the strength retrogression additive is in a concentration in the range of about 35% to about 70% by volume of the base liquid.

10. The method according to claim 1, wherein the particle sizes of the strength retrogression additive are selected from the group consisting of ultrafine, very fine, fine, small, medium, large, very large sized particles, and combinations thereof.

11. The method according to claim 10, wherein the particles of the strength retrogression additive are selected from at least two of ultrafine, very fine, fine, small, medium, large, very large sized particles.

12. The method according to claim 1, wherein the liquid concentrate is stable.

13. The method according to claim 12, wherein the liquid concentrate further comprises a suspending agent or viscosifier.

14. The method according to claim 1, wherein the liquid concentrate is pourable.

15. The method according to claim 1, wherein the cement is selected from the group consisting of Portland cements, gypsum cements, high alumina content cements, slag cements, high magnesia content cements, and combinations thereof.

16. The method according to claim 1, wherein the base liquid is water and the water of the base liquid and the cement is selected from the group consisting of freshwater, brackish water, and saltwater, in any combination thereof in any proportion.

17. The method according to claim 1, wherein the predetermined volume of the liquid concentrate is an amount such that the strength retrogression additive is in a concentration in the range of about 20% to about 70% by weight of the cement.

18. The method according to claim 1, wherein the subterranean formation is penetrated by a well.

19. The method according to claim 18, wherein the well is an oil, gas, or water production well, an injection well, a geothermal well, or a high-temperature and high-pressure well.

20. The method according to claim 1, further comprising mixing the ingredients of the cement composition using mixing equipment.

21. The method according to claim 1, wherein the cement composition is introduced into the wellbore using one or more pumps.

22. A method of cementing in a subterranean formation comprising:
providing a liquid concentrate, wherein the liquid concentrate comprises:
(A) a base liquid; and
(B) at least 40% of an active additive, wherein the active additive is a strength retrogression additive consisting of particles of silicon dioxide containing crystalline regions;
forming a cement composition by adding a predetermined volume of the liquid concentrate to at least cement and water;
introducing the cement composition into the subterranean formation; and
allowing the cement composition to set within the subterranean formation.

23. A liquid concentrate for use in a well that penetrates a subterranean formation comprising:
a base liquid; and
at least 40% of an active additive, wherein the active additive is a strength retrogression additive consisting of particles of silicon dioxide containing crystalline regions.
